(19) United States
(12) Patent Application Publication
(10) Pub. No.: US 2008/0271009 A1
(43) Pub. Date: Oct. 30, 2008

(54) SOFTWARE UPGRADE CONTROL METHOD AND BROADCAST RECEIVING APPARATUS USING THE SAME

(75) Inventors: Dong-ha LEE, Suwon-si (KR); Doh-hyeong LEE, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/049,667

(22) Filed: Mar. 17, 2008

Related U.S. Application Data
(60) Provisional application No. 60/913,627, filed on Apr. 24, 2007.

(30) Foreign Application Priority Data
Jul. 19, 2007 (KR) 10-2007-0072194

(51) Int. Cl. G06F 9/44

(52) U.S. Cl. 717/168

(57) ABSTRACT

A software upgrade control method and a broadcast receiving apparatus using the same. The software upgrade control method includes externally transmitting information relating to a card installed to the broadcast receiving apparatus and used for broadcast processing; and controlling upgrade of software of the card based on the received software upgrade which corresponds to the information relating to the installed card. Accordingly, even when the type of the card installed to the broadcast receiving apparatus varies, the correct software of the card can be upgraded.

### CROSS-REFERENCE TO RELATED APPLICATIONS

This application claims priority under 35 U.S.C. §119 from Korean Patent Application No. 10-2007-0072194, filed on Jul. 19, 2007, with the Korean Intellectual Property Office, and U.S. Provisional Application No. 60/913,627, filed Apr. 24, 2007, with the US PTO, the entire disclosure of which is hereby incorporated by reference.

### BACKGROUND OF THE INVENTION

1. Field of the Invention

Apparatuses and methods consistent with the present invention relate to a software upgrade control method and a broadcast receiving apparatus using the same, and more particularly to a method for controlling upgrade of software of a card which processes broadcasting received by a broadcast receiving apparatus, and the broadcast receiving apparatus using the same.

2. Description of the Related Art

In open cable Digital TV (DTV) or cable ready DTV on the market of the North America, a broadcast receiving apparatus requires installation of a cable card provided by the corresponding cable broadcasting provider to normally view a paid channel.

A user can use the cable card provided by the cable broadcasting provider. When the cable broadcasting provider needs to upgrade a firmware of the cable cards provided to users, to avoid the inefficient upgrade by collecting all the cable cards, it upgrades the firmware of the cable cards being distributed to the users, which is called ‘homing’.

To provide the firmware of the cable card, the cable broadcasting provider utilizes In-band channel or Out-Of-Band (OOB) channel of cable network (that is, cable line).

The upgrade method of the firmware of the cable card comprises two methods of delayed upgrade and immediate upgrade. The delayed upgrade method waits until the user finishes his/her viewing of a program in the DTV and then upgrades the firmware. The immediate upgrade method immediately upgrades the firmware regardless of the user's viewing of a program.

Meanwhile, in response to the advance of video technology with the development of broadcasting technology, the type of the cable card becomes diverse, Therefore, what is needed is a method for upgrading the firmware of the various cable cards without error.

### SUMMARY OF THE INVENTION

Exemplary embodiments of the present invention address at least the above problems and/or disadvantages and other disadvantages not described above. Also, the present invention is not required to overcome the disadvantages described above, and an exemplary embodiment of the present invention may not overcome any of the problems described above.

An aspect of the present invention has been provided to solve the above-mentioned and/or other problems and disadvantages and an aspect of the present invention provides a method for controlling software upgrade by checking whether the software of an installed card can be upgraded or not by sending information relating to the installed card externally before the installed card is upgraded, and a broadcast receiving apparatus thereof.

According to an exemplary aspect of the present invention, there is provided a software upgrade control method of a broadcast receiving apparatus including externally transmitting information relating to a card installed to the broadcast receiving apparatus and used for broadcast processing and controlling upgrade of software of the card based on the transmitted card information.

The card information may include information relating to a type of the card.

The type of the card may include a type for processing only one broadcast stream (single stream type) and a type for processing one or more broadcast stream (multi stream type).

The controlling operation may include when confirming that upgraded software of the card is provided from an external source, a first control operation of controlling to upgrade the software is performed; and when confirming that the upgraded software of the card is not provided from the external source, a second control operation of not upgrading the software is performed.

The first control operation may include when confirming that the upgraded software of the card is provided externally, requesting the upgraded software externally; receiving the upgraded software; and upgrading the card with the upgraded software.

The software upgrade control method may further include receiving a software upgrade request command from the card, wherein the transmitting operation is performed after the receiving of the request command.

The transmitting operation and the controlling operation may be performed while the broadcast receiving apparatus is in a standby state.

The software may be a firmware used for the broadcast processing by the card.

The broadcast processing may include descrambling of the broadcasting.

The broadcast may be a cable broadcasting, and the card may be a cable card however may be of other types of broadcast that may require a card such as a satellite broadcast.

According to another exemplary aspect of the present invention, there is provided a broadcast receiving apparatus including a card interface which is connected to a card used for broadcast processing, and a controller which transmits information relating to the card connected to the card interface and controls to upgrade software of the card based on a response of the transmitted card information.

The card information may be information relating to a type of the card.

The type of the card may include a type for processing only one broadcasting stream (single stream type) and a type for processing more than one broadcasting stream (multi stream type).

The controller may control to upgrade the software when confirming that upgraded software of the card is provided externally, and control not to upgrade the software when confirming that the upgraded software of the card is not provided externally.

The controller may request the upgraded software externally when confirming that the upgraded software of the card is provided from an externally source, receive the upgraded software in response to the request, and upgrading the card with the upgraded software. The controller may transmit the information relating to the card externally when a software upgrade request command is received from the card through the card interface.

The controller may transmit the information relating to the card externally and may upgrade the software of the card based on the transmitted card information while the broadcasting receiving apparatus is in a standby state.

The software may be a firmware used for the broadcast processing by the card.

The broadcast processing may include descrambling of the broadcasting.

The broadcast may be a cable broadcasting, and the card may be a cable card however may be of other types of broadcast that may require a card such as a satellite broadcast.

### BRIEF DESCRIPTION OF THE DRAWING FIGURES

The above and/or other aspects of the present invention will be more apparent by describing certain exemplary embodiments of the present invention with reference to the accompanying drawings, in which:

FIG. 1 is block diagram of a cable broadcasting system to which the present invention is applicable;

FIG. 2 is a detailed block diagram of a DTV of FIG. 1;

FIG. 3 is a block diagram of a transceiver and a broadcast processor of a DTV which can receive only one cable broadcasting at a time;

FIG. 4 is a block diagram of a transceiver and a broadcast processor of a DTV which can receive two cable broadcastings at a time;

FIG. 5 is a diagram of a firmware upgrade control method of a cable card according to an embodiment of the present invention;

FIG. 6 is a block diagram of a broadcast receiving apparatus according to another embodiment of the present invention;

FIG. 7 is a flowchart of a software upgrade control method of the broadcast receiving apparatus according to another embodiment of the present invention;

FIG. 8 is a diagram of CableCARD Interface 2.0 (CCIF2.0) specification relating to the homing; and

FIG. 9 is a diagram of contents to be applied to CCIF2.0 according to an embodiment of the present invention.

### DETAILED DESCRIPTION OF THE EXEMPLARY EMBODIMENTS

Certain exemplary embodiments of the present invention will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the present invention can be carried out without those specifically defined matters. Also, well-known functions or constructions are not described in detail since they would obscure the invention with unnecessary detail.

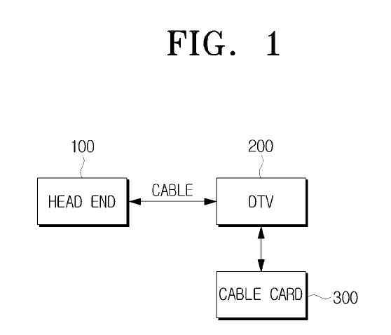

FIG. 1 is block diagram of a cable broadcasting system to which the present invention is applicable. The cable broadcasting system of FIG. 1 comprises a head end 100, a DTV 200, and a cable card 300.

The head end 100 is a cable broadcasting provider which provides cable broadcasting to the DTV 200 through a cable.

The DTV 200 is a broadcast receiving apparatus which forwards the cable broadcasting received from the head end 100 to a user. The cable card 300 is installed to the DTV 100.

The cable card 300 descrambles the scrambled cable broadcasting received at the DTV 200. Mainly, the paid cable broadcasting is scrambled and received at the DTV 200.

The cable card 300 can be divided into two types. One type is a cable card which can descramble only one cable broadcasting at a time (hereafter, referred to as a S-card), and the other type is a cable card which can descramble two or more cable broadcasting at a time (hereafter, referred to as a M-card).

Both the S-card and the M-card require a firmware to descramble the cable broadcasting. The firmware can be upgraded.

The firmware is upgraded such that the head end 100 transfers the upgraded firmware to the cable card 300 through a broadcast receiving element of the DTV 200.

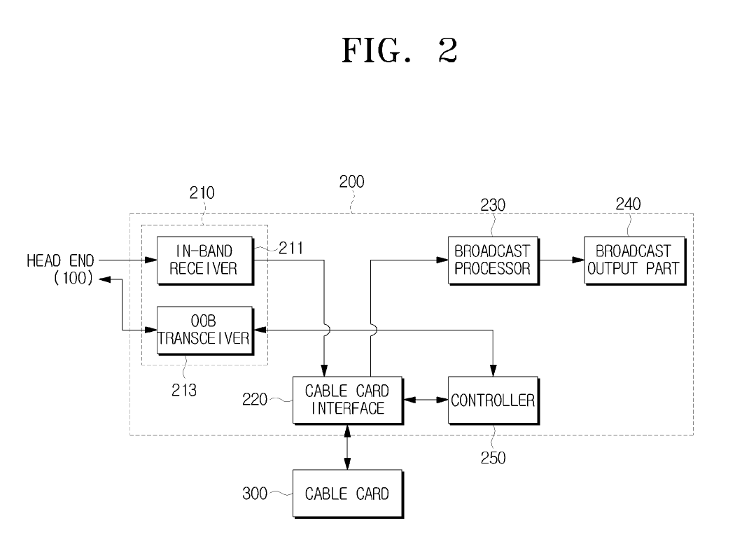

Now, the DTV 200 of FIG. 1 is described in further detail by referring to FIG. 2. FIG. 2 is a detailed block diagram of the DTV 200 of FIG. 1. To ease the understanding, the cable card 300 is also depicted in FIG. 2 in addition to the DTV 200.

As shown in FIG. 2, the DTV 200 comprises a transceiver 210, a cable card interface 220, a broadcast processor 230, a broadcast output part 240, and a controller 250.

The transceiver 210 comprises an In-band receiver 211 and an Out-Of-Band (OOB) transceiver 213. The In-band receiver 211 receives and demodulates the cable broadcasting from the head end 100 through the cable. The OOB transceiver 213 is connected to the head end 100 through the cable to enable two-way data communication between the DTV 200 and the head end 100.

The cable card interface 220 is connected to the cable card 300 to enable communications. The cable card interface 220 forwards the cable broadcasting output from the In-band receiver 211 to the cable card 300.

The cable card 300 descrambles the cable broadcasting and provides the descrambled cable broadcasting to the cable card interface 220.

The cable card interface 220 forwards the descrambled cable broadcasting provided from the cable card 300 to the broadcast processor 230.

The broadcast processor 230 decodes and scales the descrambled cable broadcasting provided through the cable card interface 220.

The broadcast output part 240 provides the processed cable broadcasting output from the broadcast processor 230 to the user through a display and a speaker.

The transceiver 210 and the broadcast processor 230 are described in further detail.

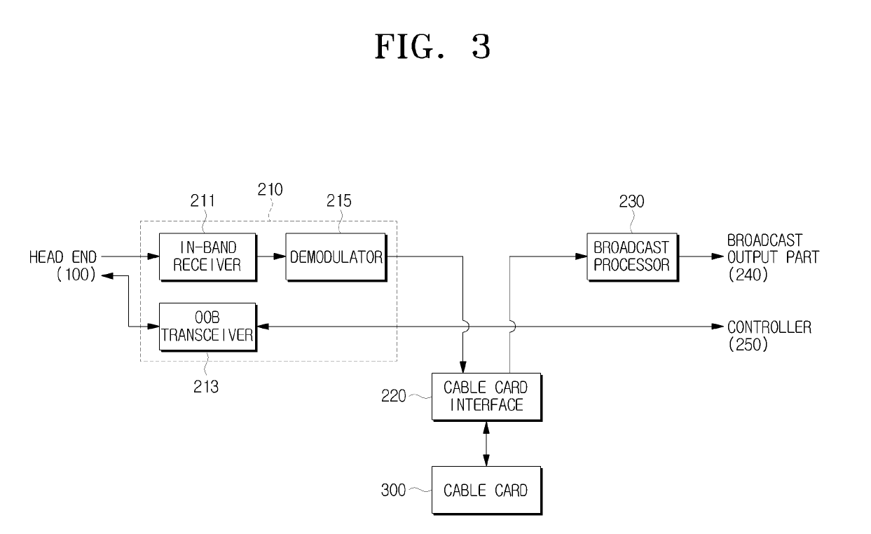

FIG. 3 is a block diagram of the transceiver 210 and the broadcast processor 230 of the DTV which can receive only one cable broadcasting at a time. To ease the understanding, the cable card interface 220 and the cable card 300 are also depicted in FIG. 3 in addition to the transceiver 210 and the broadcast processor 230.

As shown in FIG. 3, the transceiver 210 comprises the In-band receiver 211, a demodulator 215, and the OOB transceiver 213. The In-band receiver 211 tunes to one of the cable broadcastings received from the head end 100 through the cable. The demodulator 215 demodulates the cable broadcasting tuned by the In-band receiver 211.

The cable broadcasting demodulated by the demodulator 215 is fed to the cable card interface 220 through the cable card 200, descrambled, processed at the broadcast processor 230, and then output to the broadcast output part 240.

Note that the cable card 300 can be the S-card or the M-card.

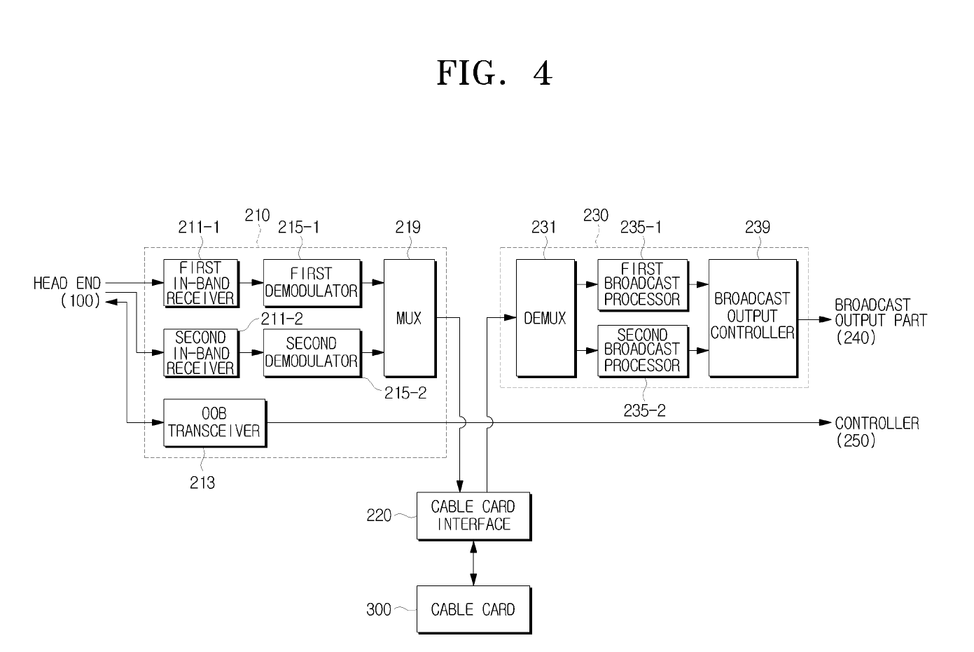

FIG. 4 is a block diagram of a transceiver 210 and a broadcast processor 230 of a DTV which can receive two cable broadcastings at a time. To ease the understanding, a cable card interface 220 and a cable card 300 are also depicted in FIG. 4 in addition to the transceiver 210 and the broadcast processor 230.

The transceiver 210 of FIG. 4 comprises a first In-band receiver 211-1, a first demodulator 215-1, a second in-band receiver 211-2, a second demodulator 215-2, a MUX 219, and an OOB transceiver 213.

The first in-band receiver 211-1 tunes to one of the cable broadcastings received from the head end 100 through the cable. The first demodulator 215-1 demodulates the cable broadcasting tuned by the first in-band receiver 211-1.

The second in-band receiver 211-2 tunes to one of the cable broadcastings received from the head end 100 through the cable. The second demodulator 215-2 demodulates the cable broadcasting tuned by the second in-band receiver 211-2.

The MUX 219 provides the first cable broadcasting output from the first demodulator 215-1 and the second cable broadcasting output from the second demodulator 215-2 to the cable card interface 220 in the alternative manner.

The cable card interface 220 forwards the first cable broadcasting and the second cable broadcasting provided from the MUX 219 in the alternative manner to the cable card 300 to descramble them, and forwards the descrambled first and second cable broadcastings from the cable card 300 to the broadcast processor 230. At this time, the cable card 300 is the M-card.

The broadcast processor 230 comprises a DEMUX 231, a first broadcast processor 235-1, a second broadcast processor 235-2, and a broadcast output controller 239.

The DEMUX 231 provides the descrambled cable broadcastings fed from the cable card interface 220 to the first broadcast processor 235-1 and the second broadcast processor 235-2 in the alternative manner. Accordingly, the descrambled first cable broadcasting is applied to the first broadcast processor 235-1, and the descrambled second cable broadcasting is applied to the second broadcast processor 235-2.

The first broadcast processor 235-1 decodes and scales the descrambled first cable broadcasting. The second broadcast processor 235-2 decodes and scales the descrambled second cable broadcasting.

The broadcast output controller 239 selects either the first cable broadcasting output from the first broadcast processor 235-1 or the second cable broadcasting output from the second broadcast processor 235-2 and outputs the selected cable broadcasting to the broadcast output part 240, or output one of the first cable broadcasting and the second cable broadcasting as a main screen and the other as a sub-screen using a Picture In Picture (PIP).

Referring back to FIG. 2, the controller 250 of the DTV 200 is explained in detail.

The controller 250 controls the in-band receiver 211, the cable card interface 220, the broadcast processor 230, and the broadcast output part 240 to receive and display the cable broadcasting demanded by the user in the screen.

The controller 250 involves the firmware upgrade of the cable card 300, which is described in detail by referring to FIG. 5. In the mean time, while the controller 250 or the DTV 200 including the controller 250 may be called a host in relation with the cable card 300, it shall be designated as the controller 250 to ease the understanding.

FIG. 5 is a diagram of a firmware upgrade control method of the cable card according to an embodiment of the present invention.

As shown in FIG. 5, when the DTV 200 enters a standby state (S505-Y), the controller 250 of the DTV 200 sends a message “open_homing” to the cable card 300 through the cable card interface 220 (S510).

In response to the message “open_homing”, the cable card 300 sends a message “open_homing_reply” to the controller 250 through the cable card interface 220 (S515). The controller 250 sends a message “homing_active” to the cable card 300 through the cable card interface 220 (S520).

Next, the cable card 300 sends a message “firmware_upgrade” to the controller 250 through the cable card interface 220 (S525).

The controller 250 sends a message “firmware_cardtype” to the head end 100 through the OOB transceiver 213 of the transceiver 210 (S530). The message “firmware_cardtype” comprises information relating to the type of the cable card 300 installed in the DTV 200 (that is, connected to the cable card interface 220). As mentioned earlier, the cable card 300 may be the S-card or the M-card.

The controller 250 can acquire the type of the cable card 300 by determining which one of pins of the cable card interface 220 is connected to the installed cable card 300. The pin for interconnecting the cable card 300 with the cable card interface 220 varies depending on the cable card 300. There may be other ways of determining which type of a card is installed, such as accessing card type information stored in a memory within the card.

In response to the message “firmware_cardtype”, the head end 100 sends a message “firmware_cardtype_reply” to the controller 250 through the OOB transceiver 213 of the transceiver 210 (S535). The message “firmware_cardtype_reply” comprises information relating to the type of the cable card 300 for which the head end 100 provides the upgraded firmware. For example, as the information relating to the type of the cable card 300 of the upgraded firmware provided by the head end 100, the message “firmware_cardtype_reply” can carry ‘S-card and/or M-card’.

Next, the controller 250 examines whether the type information of the message “firmware_cardtype” sent in step S530 matches the type information of the message “firmware_cardtype_reply” received in step S535 (S540).

Step S540 corresponds to the procedure of examining whether the firmware of the cable card 300 connected to the cable card interface 220 can be upgraded or not, that is, whether the head end 100 provides the upgraded firmware for the cable card 300 connected to the cable card interface 220.

When the two type information match (S540-Y), the controller 250 controls the in-band receiver 211 of the transceiver 210 to tune to the channel for receiving the upgraded firmware (S545).

The controller 250 sends a message “firmware_upgrade_reply” to the cable card 300 through the cable card interface 220 (S550). The message “firmware_upgrade_reply”, which is sent to inform the cable card 300 of the firmware upgrade, corresponds to a response message in reply to the message “firmware_upgrade” received from the cable card 300 in step 525.

The controller 250 sends a message “firmware_upgrade_request” to the head end 100 through the OOB transceiver 213 of the transceiver 210 (S555).

In response to the message “firmware_upgrade_request” of step S555, the head end 100 transmits the upgraded firmware for the cable card 300 through the cable, and the upgraded firmware is received at the in-band receiver 211 of the transceiver 210 and downloaded to the cable card 300 through the cable card interface 220 (S560).

Upon completing the download of the upgraded firmware, the cable card 300 sends a message “firmware_upgrade_complete” and a message “homing_complete” to the controller 250 through the cable card interface 220 (S565 and S570). The message “firmware_upgrade_complete” informs the controller 250 of the completion of the firmware upgrade, and the message “homing_complete” finishes the homing.

Next, the cable card 330 operates using the upgraded firmware by initializing itself (S575).

Meanwhile, when the two type information do not match (S540-N), the controller 250 sends a message “firmware_upgrade_cancelled” to the cable card 300 through the cable card interface 220 (S580) and sends a message “firmware_upgrade_cancelled” to the head end 100 through the OOB transceiver 213 of the transceiver 210 (S585).

The message “firmware_upgrade_cancelled” informs the cable card 300 and the head end 100 of the unupgradable firmware of the cable card 300. The message “firmware_upgrade_cancelled” can carry information relating to the cause of the unupgradable firmware (for example, mismatch of the type of the cable card).

The cable card 300 sends a message “homing_cancelled” to the controller 250 through the cable card interface 220 (S590). The message “homing_cancelled” is sent to cancel the homing.

So far, the control method of the firmware upgrade of the cable card 300 installed in the DTV 200 by the controller 250 has been illustrated according to an embodiment of the present invention.

In the embodiment of the present invention, it is assumed that the controller 250 sends the message “firmware_upgrade_request” to the head end 100 when the firmware of the cable card 300 can be upgraded, and that the controller 250 sends the message “firmware_upgrade_cancelled” to the head end 100 when the firmware of the cable card 300 cannot be upgraded.

Regardless of the upgradability of the firmware of the cable card 300, the controller 250 may send the message “firmware_upgrade_request” to the head end 100 and the message “firmware_upgrade_request” may comprise various request or information.

For example, the message “firmware_upgrade_request” can comprise firmware upgrade request, firmware upgrade cancel request, card type re-response request (re-request information relating to the type of the cable card 300 providing the upgraded firmware), card type mismatch information (information informing of the mismatch of the type information of the message “firmware_cardtype” sent in step S530 and the type information of the message “firmware_cardtype_reply” sent in step S535), and information informing of the ready state of the host (the controller 250). In this case, the controller 250 can send the message “firmware_upgrade_request” including the firmware upgrade cancel request or the message “firmware_upgrade_request” including the card type re-response request to the head end 100 in step S580, instead of the message “firmware_upgrade_cancelled”.

In the embodiment of the present invention, the DTV is merely an example of the broadcast receiving apparatus. The present invention is not limited to the DTV but applicable to other broadcast receiving apparatus than the DTV. Examples of the broadcast receiving apparatus comprise a Set-Top Box (STB), a Digital Multimedia Broadcasting (DMB) receiver, IPTV, and portable devices having the broadcast receiving function (e.g., mobile phone, navigator, and Personal Multimedia Player (PMP)).

While the firmware is upgraded by way of example, the present invention is applicable to other software as well as the firmware.

While the cable card is the S-card or the M-card by way of example, the present invention is applicable to other types of cards having a different function and/or structure (e.g., PCMCIA card).

In the embodiment of the present invention, the firmware is upgraded after the DTV 200 enters the standby state according to the delayed upgrade method. The present invention is applicable to the immediate upgrade method of upgrading the firmware regardless of the standby state entrance. In this case, steps S505 through S520, S570, and S590 are omitted.

The open_homing corresponding to steps S510 through S520 can be carried out in the process of steps S525 through S550.

While the cable card is the card for descrambling the cable broadcasting to ease the understanding, the present invention is applicable to the cable card which executes other types of security processings; as well as other types of processing to the cable broadcast unrelated to the security processing.

The cable broadcasting is merely an example. The present invention is applicable to other broadcasting than the cable broadcasting. Hence, the present invention is applicable to cards other than the cable card.

Furthermore, various combinations of above noted (or noted elsewhere in the description) possible implementations may be made as would be apparent to one of ordinarily skilled in the art.

In the embodiment of the present invention, the controller 250 sends the message “firmware_cardtype” including the information as to the type of the cable card 300 installed to the DTV 200 to the head end 100, and receives the message “firmware_cardtype_reply” including the information as to the type of the cable card 300 of which the upgraded firmware is provided by the head end 100 in response.

Instead, the head end 100 may request the information as to the type of the cable card 300 of the upgraded firmware, without the controller 250 sending the information as to the type of the cable card 300 installed to the DTV 200 to the head end 100.

Steps S530 and S535 are performed after step S525 by way of example. The order of those steps is not limited. Accordingly, steps S530 and S535 may be carried out before step S525 or step S505.

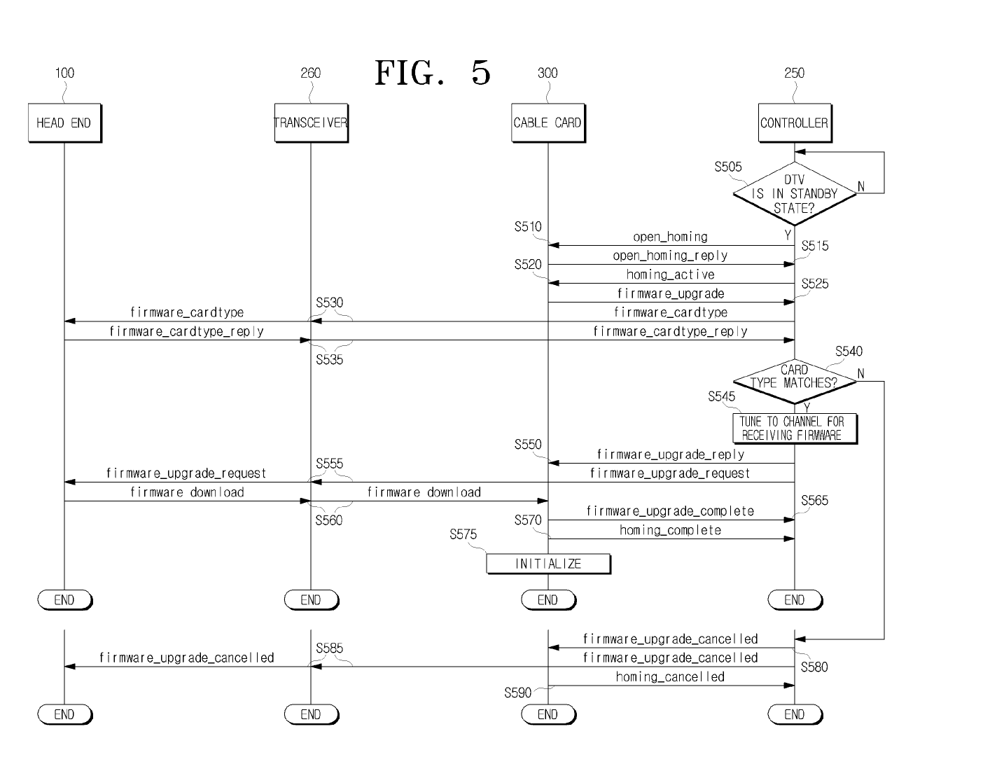

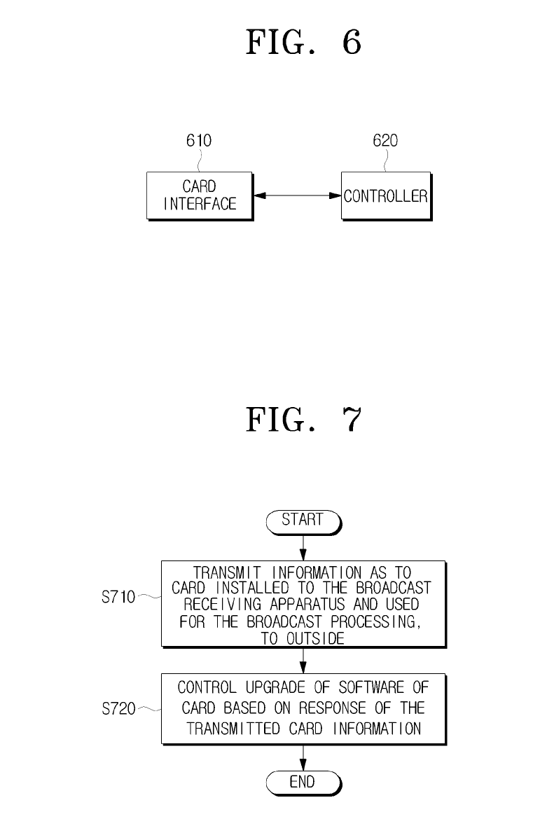

Now, another embodiment of the present invention is explained by referring to FIGS. 6 and 7.

A broadcast receiving apparatus of FIG. 6 comprises a card interface 610 and a controller 620.

The card interface 610 is connected to a card used for the broadcast processing. The controller 620 transmits information as to the card connected to the card interface 610 to outside. The controller 620 controls the upgrade of software of the card based on a response of the transmitted card information.

According to a software upgrade control method of the broadcasting receiving apparatus in FIG. 7, the broadcast receiving apparatus transmits information as to the card installed to the broadcast receiving apparatus and used for the broadcast processing to outside (S710).

Next, the broadcast receiving apparatus controls the upgrade of the software of the card based on a response of the transmitted card information (S720).

Therefore, the software upgrade of the card installed to the broadcast receiving apparatus can be controlled.

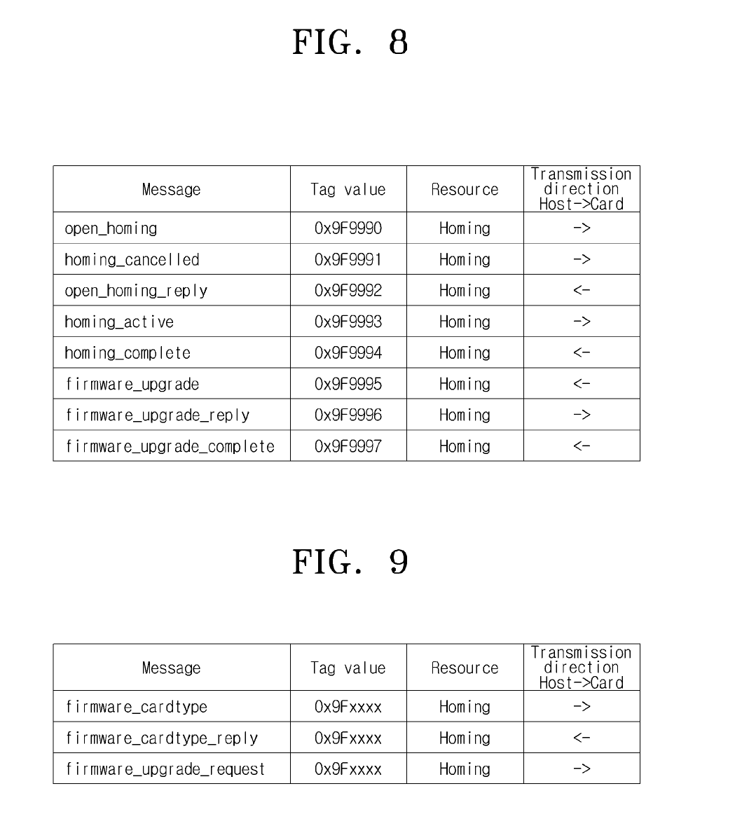

FIG. 8 shows tag value, resource, and transmission direction of messages relating to the homing according to the CCIF 2.0 specification. Since the meaning and the function of the messages have been described in FIG. 5, their further explanation shall be omitted. In FIG. 8, the host indicates the controller 250 of FIG. 5 in terms of the transmission direction.

FIG. 9 shows tag value, resource, and transmission direction of messages which can be added to the CCIF 2.0 according to an embodiment of the present invention. Since the meaning and the function of those messages have been described in FIG. 5, their further explanation shall be omitted.

As set forth above, the software upgrade is controlled by checking whether the software of the installed card can be upgraded or not before the installed card is actually upgraded. Therefore, even when the type of the card installed to the broadcast receiving apparatus varies, the software of the card can be upgraded without error.

Consequently, error caused by the upgrade failure in the broadcast reception can be avoided, and the degradation of the performance of the broadcasting receiving apparatus or the card can be prevented in advance.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A software upgrade control method of a broadcast receiving apparatus, comprising:
transmitting information relating to a card installed to the broadcast receiving apparatus in which the card is used for broadcast processing; and
receiving a software upgrade for upgrading the software of the card, wherein the software upgrade corresponds to the information relating to the card.

2. The software upgrade control method of claim 1, wherein the card information is information relating to a type of the card.

3. The software upgrade control method of claim 2, wherein the type of the card comprises a type for processing single broadcast and a type for processing one or more broadcast at a time.

4. The software upgrade control method of claim 1, further comprising the step of:
receiving an information indicating an available software upgrade from an external source after the transmitting step,

5. The software upgrade control method of claim 4, further comprising the step of:
requesting the software upgrade when confirming that the software upgrade of the installed card is available from the external source.

6. The software upgrade control method of claim 1, further comprising:
receiving a software upgrade request command from the card,
wherein the transmitting operation is performed after the receiving the software upgrade request command from the card.

7. The software upgrade control method of claim 1, wherein the transmitting operation and the receiving operation are performed while the broadcast receiving apparatus is in a standby state.

8. The software upgrade control method of claim 1, wherein the software is a firmware used for the broadcast processing by the card.

9. The software upgrade control method of claim 1, wherein the broadcast processing is descrambling of the broadcasting.

10. The software upgrade control method of claim 1, wherein the broadcasting is a cable broadcasting, and
the card is a cable card.

11. A broadcast receiving apparatus comprising:
a card interface which is connected to a card used for broadcast processing; and
a controller which transmits information relating to the card connected to the card interface and controls to upgrade software of the card based on a response of the transmitted card information.

12. The broadcast receiving apparatus of claim 11, wherein the card information is information relating to a type of the card.

13. The broadcast receiving apparatus of claim 12, wherein the type of the card comprises a type for processing one broadcasting and a type for processing at least one broadcasting at a time.

14. The broadcast receiving apparatus of claim 11, wherein the controller controls to upgrade the software when confirming that upgraded software of the card is provided from outside according to the response, and controls not to upgrade the software when confirming that the upgraded software of the card is not provided from outside according to the response.

15. The broadcast receiving apparatus of claim 14, wherein the controller requests the upgraded software to outside when confirming that the upgraded software of the card is provided from outside according to the response, receives the upgraded software in response to the request, and controls to upgrade with the upgraded software.

16. The broadcast receiving apparatus of claim 11, wherein the controller transmits the information relating to the card to outside when a software upgrade request command is received from the card through the card interface.

17. The broadcast receiving apparatus of claim 11, wherein the controller transmits the information relating to the card to outside and controls to upgrade the software of the card based on a response of the transmitted card information while the broadcasting receiving apparatus is in a standby state.

18. The broadcast receiving apparatus of claim 11, wherein the software is a firmware used for the broadcast processing by the card.

19. The broadcast receiving apparatus of claim 11, wherein the broadcast processing is descrambling of the broadcasting.

20. The broadcast receiving apparatus of claim 11, wherein the broadcasting is a cable broadcasting, and
the card is a cable card.

21. The software upgrade control method of claim 1, wherein the broadcast receiving apparatus is a satellite broadcast receiver.

22. The software upgrade control method of claim 1, further comprising the step of: controlling to upgrade the card with the received software upgrade.

23. The software upgrade control method of claim 1, wherein the card is of a multi-stream type which is capable of processing one or more broadcast stream.

24. The software upgrade control method of claim 1, wherein the broadcast receiving apparatus is capable of receiving and processing two broadcast channels simultaneously.

25. The software upgrade control method of claim 22, further comprising the step of initializing the card after the upgrade of the card has been finished.
